(19) United States
(12) Patent Application Publication
(10) Pub. No.: US 2004/0240692 A1
(43) Pub. Date: Dec. 2, 2004

(54) Magnetic coupling adaptor

(76) Inventor: Stephen D. Julstrom, Chicago, IL (US)

Correspondence Address: MCANDREWS HELD & MALLOY, LTD, 500 WEST MADISON STREET, SUITE 3400, CHICAGO, IL, 60661

(21) Appl. No.: 10/877,570

(22) Filed: Jun. 25, 2004

Related U.S. Application Data
(63) Continuation-in-part of application No. 10/356,290, filed on Jan. 31, 2003.
Application No. 10/356,290 is a continuation-in-part of application No. 09/752,806, filed on Dec. 28, 2000, now Pat. No. 6,694,034.

(51) Int. Cl. H04R 25/00

(52) U.S. Cl. 381/315; 381/312

(57) ABSTRACT

Disclosed herein is an adaptor for use with a mobile cellular telephone, a combination cellphone/adaptor, and a method of using a hearing aid with a cellphone employing an adaptor according to an embodiment of the present invention. The adaptor may include a microphone, a battery, an inductor, and electronic circuitry disposed on a circuit board. The microphone may be positioned generally over receiver acoustic openings of the cellphone. The adaptor may be adapted to amplify a microphone signal to drive an inductor. The inductor may be located at an end of the adaptor. The inductor field may be concentrated in a region where a magnetic noise field associated with cellphone circuitry may be much lower.

### CROSS-REFERENCE TO OTHER APPLICATIONS

The present application hereby incorporates herein by reference the complete subject matter of the following U.S. Provisional Patent Applications: Ser. No. 60/174,958, filed on Jan. 7, 2000, Ser. No. 60/225,840, filed on Aug. 16, 2000, and Ser. No. 60/459,865, filed on Apr. 1, 2003, in their respective entireties.

The present application is a continuation-in-part of U.S. Non-Provisional Patent Application having Ser. No. 10/356,290, entitled “Multi-Coil Coupling System for Hearing Aid Applications”, and filed on Jan. 31, 2003, which is hereby incorporated herein by reference, in its entirety.

The present application is also a continuation-in-part of U.S. Non-Provisional Patent Application having Ser. No. 09/752,806, entitled “Transmission Detection and Switch System for Hearing Improvement Applications”, and filed on Dec. 28, 2000, which is hereby incorporated herein by reference, in its entirety.

The present application also hereby incorporates herein by reference the complete subject matter of U.S. Pat. No. 6,009,311, issued on Dec. 28, 1999, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Hearing aids typically receive sound pickup from an integral microphone. Many hearing aids are also equipped with an inductive pickup called a telecoil. The original use for this input was to pick up audio signal contained in the stray magnetic field from telephone receivers so that the user could listen clearly to the telephone signal without interfering environmental sounds being picked up by the microphone. Telecoil use has grown to include “room loop” systems, wherein a desirable audio frequency magnetic field is produced throughout a room, and accessories such as “neck loops”, wherein a desirable audio frequency magnetic field is produced in the region of a user's head, and “ear hooks”, wherein a desirable audio frequency magnetic field is produced more specifically in the region of a user's hearing aid.

Increasingly, cellular telephones (cellphones) are becoming as ubiquitous, and as necessary, as conventional wired telephones have long been. However, most hearing aid users are not able to use modem cellphones with their hearing aid in the telecoil mode.

Further limitations and disadvantages of conventional and traditional approaches will become apparent to one of skill in the art, through comparison of such systems with some aspects of the present invention as set forth in the remainder of the present application with reference to the drawings appended hereto.

### SUMMARY OF THE INVENTION

Aspects of the present invention may be found in an adaptor attachable to an electronic device. The adaptor may be adapted to interface between the electronic device and a hearing aid. The adaptor may comprise a power supply, a signal-receiving device, and a magnetic field-generating device. The adaptor may be adapted to receive a signal from the electronic device and use the received signal to drive the magnetic field-generating device to magnetically couple with the hearing aid, permitting a user of the hearing aid to receive the signal from the electronic device.

In an embodiment according to the present invention, the signal-receiving device may be one of a microphone and an earphone jack.

In an embodiment according to the present invention, the adaptor may be adapted to generate a magnetic field and position the magnetic field in a region comprising a weak magnetic noise field.

In an embodiment according to the present invention, the adaptor may be adapted to generate a magnetic field and position the magnetic field in a region of reduced radio frequency energy.

In an embodiment according to the present invention, the adaptor may be adapted to be attached to the electronic device and generate and position a magnetic field in a region at least a distance away from the electronic device.

In an embodiment according to the present invention, the adaptor may be adapted to generate a magnetic field comprising strong components in directions adapted for coupling with at least one telecoil in a hearing aid.

In an embodiment according to the present invention, the adaptor may be adapted to generate a magnetic field comprising strong components along directions that in use are vertical and outwardly directed horizontal with respect to the head of the hearing aid user.

In an embodiment according to the present invention, the magnetic field-generating device may comprise an inductor. The inductor may be provided with a shape adapted to overcome magnetic noise field characteristics of an associated electronic device.

In an embodiment according to the present invention, the inductor may comprise a rod inductor.

In an embodiment according to the present invention, the rod inductor may comprise an iron core and may have a winding about a central portion of the iron core.

In an embodiment according to the present invention, the iron core may have a diameter of approximately 0.6 mm, wherein the winding may have a diameter of approximately 1 mm and a length along the iron core of approximately 12 mm.

In an embodiment according to the present invention, the inductor may produce strong magnetic field components along directions that in use are vertical and outwardly directed horizontal with respect to the head of the hearing aid user.

In an embodiment according to the present invention, the adaptor may be adapted to operate with a low operating power until encountering an input having a sufficient strength to cause the adaptor to enter an active mode.

In an embodiment according to the present invention, the adaptor may further comprise a low idle power and a power-up circuit activated upon sensing a signal.

In an embodiment according to the present invention, the adaptor may further comprise frequency-shaping capabilities. The adaptor may be adapted to produce a flat, band-limited response from a telecoil circuit in a hearing aid over a particular frequency range.

In an embodiment according to the present invention, the particular frequency range may comprise 300 Hz to 3 kHz.

Aspects of the present invention may be found in a method of interfacing between an electronic device and a hearing aid. The method may comprise receiving a signal from the electronic device at an adaptor, driving a magnetic field-generating device in the adaptor with the received signal, producing a magnetic field having a particular shape and direction by the adaptor, coupling the hearing aid magnetically to the magnetic field produced by the adaptor, and receiving the signal from the electronic device as an audible signal by a user of the hearing aid.

In an embodiment according to the present invention, receiving a signal from the electronic device at the adaptor may be accomplished via a signal-receiving device comprising one of a microphone and an earphone jack.

In an embodiment according to the present invention, producing the magnetic field having a particular shape and direction by the adaptor may comprise generating and positioning the generated magnetic field in a region comprising a weak magnetic noise field.

In an embodiment according to the present invention, producing the magnetic field having a particular shape and direction by the adaptor may comprise generating and positioning the generated magnetic field in a region of reduced radio frequency energy.

In an embodiment according to the present invention, producing the magnetic field having a particular shape and direction by the adaptor may comprise generating and positioning the generated magnetic field in a region at least a distance away from the electronic device.

In an embodiment according to the present invention, producing the magnetic field having a particular shape and direction by the adaptor may comprise generating a magnetic field comprising strong components in directions adapted for coupling with at least one telecoil in a hearing aid.

In an embodiment according to the present invention, producing the magnetic field having a particular shape and direction by the adaptor may comprise generating a magnetic field comprising strong components along directions that in use are vertical and outwardly directed horizontal with respect to the head of the hearing aid user.

In an embodiment according to the present invention, producing the magnetic field having a particular shape and direction by the adaptor may be performed by a magnetic field-generating device comprising an inductor, the inductor may be provided with a shape adapted to overcome magnetic noise field characteristics of an associated electronic device.

In an embodiment according to the present-invention, the inductor may comprise a rod inductor.

In an embodiment according to the present invention, the rod inductor may comprise an iron core and a winding about a central portion of the iron core.

In an embodiment according to the present invention, the iron core may have a diameter of approximately 0.6 mm and the winding may have a diameter of approximately 1 mm and a length along the iron core of approximately 12 mm.

In an embodiment according to the present invention, the inductor may produce strong magnetic field components along directions that in use are vertical and outwardly directed horizontal with respect to the head of the hearing aid user.

In an embodiment according to the present invention, the method may further comprise operating the adaptor with a low operating power until encountering an input having a sufficient strength to cause the adaptor to enter an active mode.

In an embodiment according to the present invention, the method may further comprise operating the adaptor with a low idle power until powering-up based upon sensing a signal.

In an embodiment according to the present invention, the method may further comprise shaping frequency characteristics comprising a flat, band-limited response over a particular frequency range.

In an embodiment according to the present invention, the particular frequency range may comprise 300 Hz to 3 kHz.

These and various other advantages and features of novelty which characterize the invention are pointed out with particularity in the claims annexed hereto and that form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF SEVERAL VIEWS OF THE DRAWINGS

FIG. 1 is a perspective diagram illustrating a cutaway portion of a mobile cellular telephone employing an exemplary magnetic coupling adaptor according to an embodiment of the present invention;

FIG. 2A is a cutaway side-view diagram illustrating interior components of an exemplary magnetic coupling adaptor according to an embodiment of the present invention;

FIG. 2B is a cutaway front-view diagram illustrating interior components of an exemplary magnetic coupling adaptor according to an embodiment of the present invention;

FIG. 2C is a graph illustrating exemplary inductor drive voltages and resultant telecoil coupling response versus frequency for an exemplary magnetic coupling adaptor according to an embodiment of the present invention;

FIG. 3 is a block diagram illustrating functional components of an exemplary magnetic coupling adaptor according to an embodiment of the present invention;

FIG. 4 is a circuit diagram illustrating a microphone and microphone preamplifier circuit of an exemplary magnetic coupling adaptor according to an embodiment of the present invention;

FIG. 5 is a circuit diagram illustrating output circuitry of an exemplary magnetic coupling adaptor according to an embodiment of the present invention; and

FIG. 6 is a circuit diagram illustrating output enable and supply bypassing circuitry of an exemplary magnetic coupling adaptor according to an embodiment of the present invention.

### DETAILED DESCRIPTION OF THE INVENTION

One reason that most hearing aid users are not able to use modern cellphones with a hearing aid in a telecoil mode is because strong radio frequency (RF) energy emitted by a cellphone antenna interferes with the hearing aid. This is especially problematic with digital cellphones whose RF signal modulation envelope contains strong audio frequency components. Such radio frequency interference (RFI) can also affect hearing aids in a microphone mode. Many newer hearing aids and hearing aid components are being designed with improved radio frequency immunity, which may address this problem as long as the RF field is not too strong. To aid in addressing this problem, some cellphones may be designed so that their antennae are positioned farther from the hearing aid in normal use.

Another reason that most hearing aid users are not able to use modern cellphones with a hearing aid in a telecoil mode is that the receivers employed in cellphones are, of necessity, very small compared to traditional handset receivers, and often produce weak external magnetic fields that are insufficient for effective telecoil use. A receiver's strongest field may be produced along the receiver axis, perpendicular to the face of the cellphone, with the maximum field in other directions being approximately 10 dB weaker. While some in-the-ear (ITE) hearing aid telecoils are positioned to pick up a receiver's stronger “axial” field, most behind-the-ear (BTE) aids, along with ITE hearing aids designed to be compatible with room loop systems, have telecoils positioned for maximum sensitivity to fields that are vertical in use. This direction of the magnetic field from a cellphone receiver is approximately 10 dB weaker than the receiver's stronger “axial” direction, which is still often fairly weak.

To address the problem set forth above, a cellphone receiver may be designed to have sufficiently strong magnetic fields in the cellphone receiver's “radial” directions, i.e., directions perpendicular to the receiver's axis. While this may have been previously attempted, there is a design conflict between achieving both the appropriate magnetic and acoustic levels and frequency responses. The use of an auxiliary magnetic field-generating element may also be possible. However, unless separate driving means are employed for the receiver and the auxiliary magnetic field-generating inductor, the frequency response conflict may not be overcome. Current cellphones have generally not addressed the above-stated problem.

Yet another reason that most hearing aid users are not able to use modem cellphones with a hearing aid in a telecoil mode is that digital cellphones produce very significant levels of audio frequency magnetic interference. Electrical currents feeding various parts of the cellphone circuitry produce the magnetic interference. Some magnetic noise comes from currents feeding, for example, a display backlighting, keypad scanning, and other internal processes. The biggest contributor to the magnetic noise field in the vicinity of a hearing aid is the current operating the antenna output amplifier. The current operating the antenna output amplifier may follow the RF modulation envelope and produce magnetic noise of a nearly identical spectral character as the noise spectrum arising from the unwanted detection of the RF signal in the hearing aid circuitry (i.e., the radio frequency interference (RFI)). The magnetic noise may be in the same frequency range as the desired magnetic signal, though, and may not be eliminated by mere design modifications to the hearing aid.

To address the above-stated problem, cellphone magnetic noise-generating current loops in the vicinity of the hearing aid telecoil, especially those feeding the RF output stage, may be minimized. The goal may be met in certain “clamshell” style cellphones, because the majority of the circuitry is contained in the lower half of the housing. Non-folding cellphone designs, often referred to as “candy bar” style cellphones, however, place the RF output circuitry near the antenna, and very near the source of the desired magnetic signal (i.e., the receiver). Such cellphones may produce not just a weak magnetic signal, but also produce a noise field in the same region that is at least as strong or stronger than the desired magnetic signal. Reducing the magnetic noise field requires careful attention to the internal wiring layout during the cellphone design process, with only limited improvement foreseeable.

Aspects of the present invention may be found in solving the above-stated problems by employing an adaptor that may be readily attached, or “clipped-on”, to a wide variety of cellphones and other related communication devices. In an embodiment according to the present invention, the adaptor may be attached over a receiver end of a cellphone. In an embodiment according to the present invention, the adaptor may extend a short distance (a few centimeters) beyond the end of the cellphone.

In an embodiment according to the present invention, the adaptor may contain an inductor capable of generating a strong magnetic field in all directions, but especially in the directions most effective in coupling to hearing aid telecoils, (i.e., when in use, vertically and horizontally away from the ear/head of a hearing aid user). The inductor may be preferentially located to produce a strong field in a region removed from cellphone magnetic noise generation.

In an embodiment according to the present invention, a combination of a strong magnetic signal field and a reduced magnetic noise field at a hearing aid telecoil location may provide high signal to noise ratio (S/N) and excellent telecoil signal pickup. In use, a cellphone/adaptor combination may be positioned slightly toward a user's mouth, in comparison to normal cellphone operation, in order to place the optimum S/N region at the hearing aid telecoil.

In an embodiment according to the present invention, signal input to the adaptor may comprise an earphone output jack on the cellphone. In an embodiment according to the present invention, when the cellphone does not have an earphone jack or earphone jack use would be inconvenient, for example, the adaptor may incorporate a microphone attached over receiver openings of the cellphone. An acoustic input picks up less interfering environmental sounds than the hearing aid's microphone does, relative to a desired receiver acoustic output, because the adaptor's microphone is placed in very close proximity to the cellphone receiver and, secondarily, due to a sealed or near-sealed coupling interface between the adapter and the cellphone.

In an embodiment according to the present invention, the frequency range may be between 100 Hz and 10 kHz. In an embodiment according to the present invention, the frequency range may be within the range of human hearing, 20 Hz to 22 kHz. The frequency response of the magnetic output develops, relative to the adaptor's electrical or acoustic input, in a manner similar to that delineated in U.S. Non-Provisional Patent Application having Ser. No. 10/356,290, entitled “Multi-Coil Coupling System for Hearing Aid Applications”, and filed on Jan. 31, 2003, except that the bandwidth may be limited to the 300 Hz-3 kHz cellphone range.

Although the adaptor may incorporate a user-activated on/off switch or a switch activated when the adaptor is attached to a cellphone, in an embodiment according to the present invention, the adaptor may avoid a need for a mechanically activated on/off switch. The adaptor circuitry may be arranged to operate at moderate current drain from a standard lithium coin cell/battery. Maintaining an extremely low idle current extends battery life. Stepping up from the low idle current to a moderate operating current in response to a significant acoustic input, and returning to the low idle current in the absence of a significant acoustic input, after period of delay, for example, may also extend the battery life.

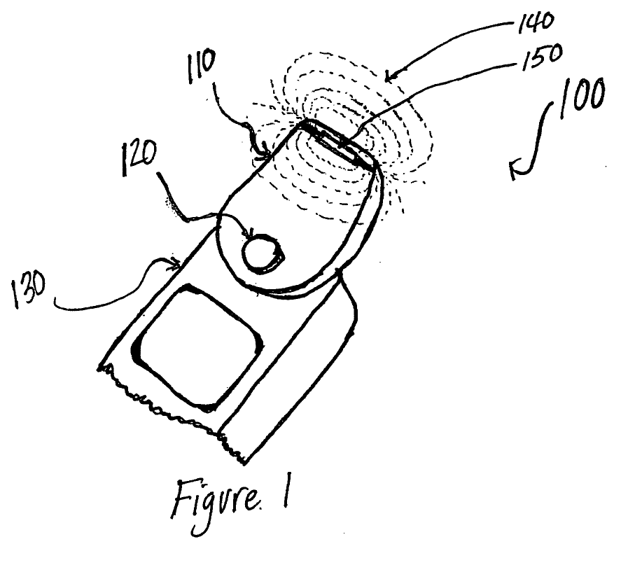

FIG. 1 is a perspective diagram illustrating an exemplary cellphone/adaptor combination 100 comprising a portion of a mobile cellular telephone 130 and an exemplary magnetic coupling adaptor 110 according to an embodiment of the present invention. In FIG. 1, the adaptor 110 is illustrated positioned on an exemplary cellphone 130. The adaptor microphone 120 may be positioned generally over a cellphone receiver's acoustic openings (not shown). Alternatively, an adaptor input signal may be taken electrically (by wire) from the cellphone via an earphone jack (not shown).

In an embodiment according to the present invention, the adaptor circuitry may amplify a microphone signal to drive an inductor 150. The inductor 150 may be located advantageously at a far extended end of the adaptor 110, for example, approximately 3 cm away from the microphone 120 and from the cellphone receiver (not shown). Thus, in comparison to a magnetic field produced by the cellphone receiver (not shown), which may be concentrated in a region of high cellphone magnetic noise, the greatest concentration of the inductor's field 140 may be in a region where, by virtue of the distance from the cellphone 130, the magnetic noise field may be much lower.

As measured, A-weighted through a hearing aid telecoil frequency response, and referred to an equivalent 1 kHz frequency level, the magnetic noise field at a telecoil distance of approximately 1 cm from/over the surface of the cellphone 130 may be about (−20 dB (A/m)) (100 mA/m) for a global system for mobile communications (GSM) “candy bar” style cellphone operating at an average transmitting power level, which may compare unfavorably to a magnetic signal level expected by a telecoil for typical human speech of only (−25 dB (A/m)). (The noise level may generally be lower for time division multiple access (TDMA) and code division multiple access (CDMA) cellphones).

By the ability of the adaptor 110 to move the magnetic signal field away from the cellphone 130, the hearing aid telecoil may be positioned (by moving the cellphone/adaptor combination 100 slightly closer to a user's mouth) in a region where the cellphone magnetic noise is at least 20 dB to 30 dB weaker than near the receiver of the cellphone 130.

At a height of approximately 1 cm above the surface of the cellphone 130, a cellphone receiver may produce a magnetic level for speech at full cellphone volume setting of about (−10 dB (A/m)) in the axial direction, directly over a receiver axis, (−20 dB (A/m)) perpendicular to the axial direction (in the radial directions), and about 0.6 cm away from the receiver axis. BTE hearing aids and many ITE hearing aids adapted to couple with an in-use vertical component of the magnetic field may respond to a receiver's weaker radial field rather than the receiver's stronger axial field, because a component of the receiver's radial field is vertical in-use.

In contrast, the inductor 150 of adaptor 110 may be driven to produce a much stronger magnetic field and may be shaped and positioned to orient the field in the directions supported by hearing aid telecoils. A rod inductor 150, for example, as illustrated and positioned in FIG. 1, may produce a strong magnetic field parallel to the inductor 150, which may be approximately vertical in-use supporting a majority of hearing aid telecoils. Off the ends of the rod inductor 150, a magnetic field of equal strength may be produced perpendicular to the face of the cellphone 130, as needed by some ITE hearing aid telecoils. The induced magnetic fields, at a height of approximately 1 cm off the surface, may reach (+10 dB (A/m)) for ordinary speech, with louder speech peaks permitted to exceed (+10 dB (A/m)) by another 20 dB.

For vertically oriented telecoils, the induced field level may be 20 dB stronger than the best cellphone receiver field and 30 dB stronger than typical cellphone receivers. In practice, the high magnetic field level may facilitate a high S/N, both against cellphone magnetic noise and against other environmental magnetic noise. The high magnetic field level may also permit an end-user to non-critically reposition the cellphone/adaptor combination 100 in relation to a hearing aid to adjust perceived volume level. In general, adjustment may involve moving the cellphone/adaptor combination 100 toward the end-user's mouth, lowering the cellphone magnetic noise pickup, lowering the RFI (by moving the cellphone antenna (not shown) farther away from the hearing aid), and improving the cellphone microphone pickup.

In an embodiment according to the present invention, a further advantage of the shape and positioning of inductor 150, illustrated in FIG. 1, may be the orientation of a magnetic noise field from a “candy bar” style cellphone, such as cellphone 130 illustrated in FIG. 1. The in-use vertical magnetic field from the cellphone receiver may be a radial field located about either side of the receiver. The magnetic noise may be generally very high in those two locations. Approximately along a centerline of the cellphone 130, where the rod inductor 150 produces an in-use vertical field, many candy bar style cellphones, such as cellphone 130, for example, may coincidentally exhibit a null region in the in-use vertical magnetic noise field. This may be due to the nature of the magnetic field produced by the RF output stage currents circulating from and back to the battery (not shown in FIG. 1), generally parallel to the surface of the cellphone 130.

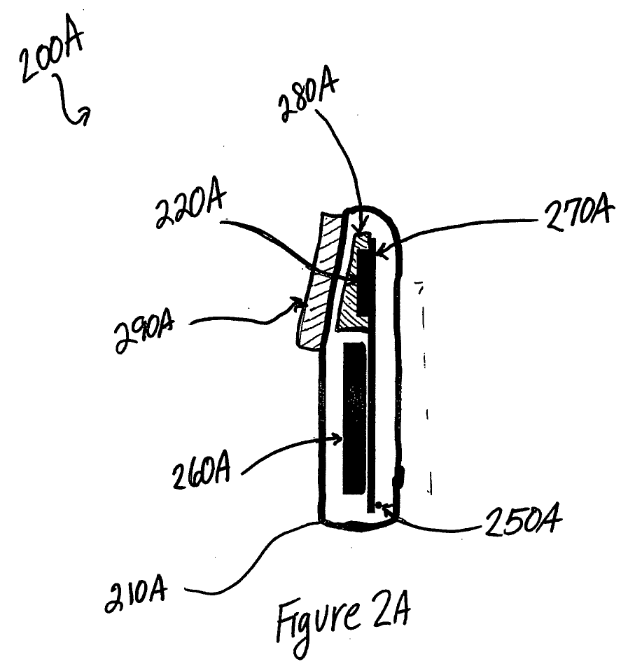

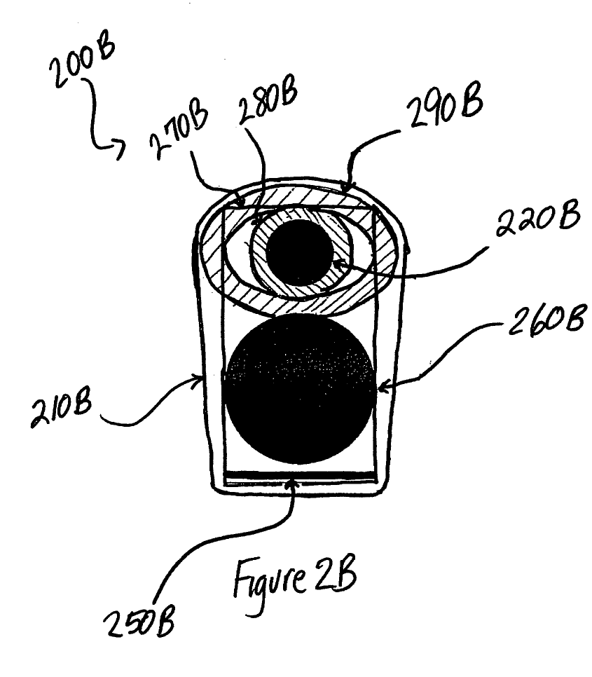

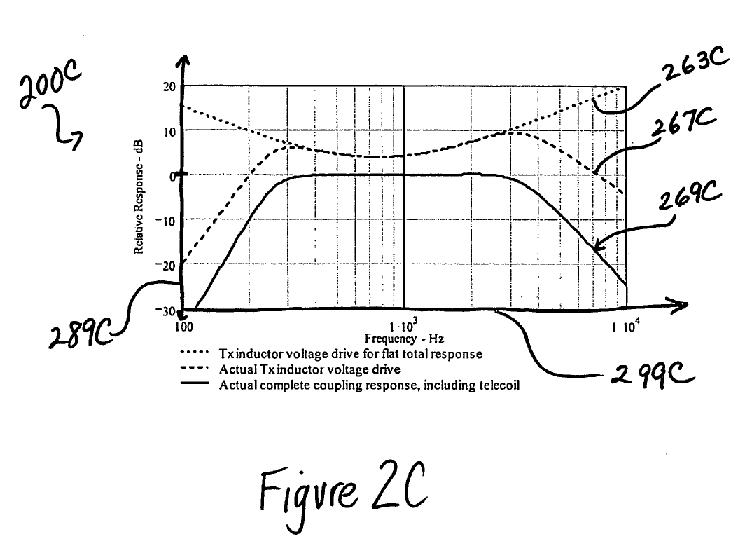

FIG. 2A is a cutaway side-view diagram 200A illustrating exemplary interior components of an exemplary magnetic coupling adaptor 210A according to an embodiment of the present invention. An attaching mechanism for coupling the adaptor 210A to a cellphone, such as cellphone 130 illustrated in FIG. 1, is not shown in FIG. 2A. Attachment of the adaptor 210A to a cellphone 130 may be accomplished by a plurality of conventional means, such as, for example, a spring clip.

In an embodiment according to the present invention, the inductor 250A and microphone 220A are illustrated mounted on opposite sides of a circuit board 270A. The inductor 250A, illustrated in FIG. 2A, may be 20 mm long, for example. In an embodiment according to the present invention, an exemplary inductor 250A may comprise a soft iron core having a diameter of approximately 0.6 mm, a winding of approximately 1 mm in diameter and approximately 12 mm in length wound around the central portion of the core, for example.

In an embodiment according to the present invention, the microphone 220A may be a Star Micronics EAA-09-AP model, for example. In an embodiment according to the present invention, the microphone 220A may be chosen from a plurality of microphones having a convenient physical shape, size, and appropriate electrical characteristics.

In an embodiment according to the present invention, the battery 260A may be a CR-2032 lithium coin cell-type battery, for example. In an embodiment according to the present invention, the battery 260A may be selected from a plurality of batteries having a convenient physical shape, size, and electrical characteristics. The selected battery 260A may physically fit within the adaptor housing (shown generally in FIG. 2A), have a long shelf life, and may produce a 3V output, for example.

In an embodiment according to the present invention, the circuitry components of the adaptor, for example, the microphone 220A and battery 260A may be located on the same side or on opposite sides of the circuit board 270A.

In an embodiment according to the present invention, the microphone 220A may be acoustically coupled to acoustical openings (not shown) in the housing of the adaptor 210A with the aid of an internal sealing gasket 280A. The internal sealing gasket 280A may be made of a compressible material.

In an embodiment according to the present invention, an external sealing gasket 290A may be employed to couple the acoustical openings (not shown) of the housing of the adaptor 210A to receiver acoustical openings (not shown) of the cellphone, such as cellphone 130 illustrated in FIG. 1, for example. In an embodiment according to the present invention, the external sealing gasket 290A may be made of a compressible material. The external sealing gasket 290A may be formed to encompass a large elliptical area, as shown in FIG. 2B, for example, to ensure inclusion of any off-center receiver acoustical openings and to accommodate different acoustical opening configurations associated with different cellphone models.

Acoustic sealing of the adaptor 210A to the surface of the cellphone 130 is desirable to minimize external sound pickup, but complete sealing is not essential. Modern cellphones employ a “leak-tolerant” design that minimizes response and level differences with variation in acoustic seals.

In an embodiment according to the present invention, the external sealing gasket 290A may also serve to secure the adaptor 210A to the cellphone 130. In an embodiment according to the present invention, the external sealing gasket 290A may have high-friction properties that along with similar gripping properties associated with the attaching mechanism (not shown) ensure secure mounting/coupling of the adaptor 210A to the cellphone 130, for example.

In an embodiment according to the present invention, a method employed to ensure a flat frequency response through a receiving telecoil may be similar to that described in U.S. Non-Provisional Patent Application having Ser. No. 10/356,290, entitled “Multi-Coil Coupling System for Hearing Aid Applications”, and filed on Jan. 31, 2003. One difference may be that a net response may be limited to 300 Hz to 3 kHz, because that is the range of typical valid acoustic input from a receiver of a cellphone 130. Any sound pickup outside of the 300 Hz to 3 kHz frequency range may be attenuated.

FIG. 2B is a cutaway front-view diagram 200B illustrating exemplary interior components of an exemplary magnetic coupling adaptor 210B according to an embodiment of the present invention. An attaching mechanism for attaching the adaptor 210B to a cellphone, such as cellphone 130 illustrated in FIG. 1, is not shown in FIG. 2B. Attachment of the adaptor 210B to a cellphone 130 may comprise a plurality of conventional means, such as, for example, a spring clip.

In an embodiment according to the present invention, the inductor 250B and microphone 220B are illustrated mounted on opposite sides of a circuit board 270B. The inductor 250B, illustrated in FIG. 2B, may be 20 mm long, for example. In an embodiment according to the present invention, an exemplary inductor 250B may comprise a soft iron core having a diameter of approximately 0.6 mm, a winding of approximately 1 mm in diameter and approximately 12 mm in length wound around the central portion of the core, for example.

In an embodiment according to the present invention, the microphone 220B may be a Star Micronics EAA-09-AP model, for example. In an embodiment according to the present invention, the microphone 220B may be chosen from a plurality of microphones having a convenient physical shape, size, and appropriate electrical characteristics.

In an embodiment according to the present invention, the battery 260B may be a CR-2032 lithium coin cell-type battery, for example. In an embodiment according to the present invention, the battery 260B may be selected from a plurality of batteries having a convenient physical shape, size, and electrical characteristics. The selected battery 260B may physically fit within the adaptor housing (shown generally in FIG. 2B), have a long shelf life, and may produce a 3V output.

In an embodiment according to the present invention, the circuitry components of the adaptor, for example, the microphone 220B and battery 260B may be located on the same side or on opposite sides of the circuit board 270B.

In an embodiment according to the present invention, the microphone 220B may be acoustically coupled to acoustical openings (not shown) in the housing of the adaptor 210B with the aid of an internal sealing gasket 280B. The internal sealing gasket 280B may be made of a compressible material.

In an embodiment according to the present invention, an external sealing gasket 290B may be employed to couple the acoustical openings (not shown) of the housing of the adaptor 210B to receiver acoustical openings (not shown) of the cellphone, such as cellphone 130 illustrated in FIG. 1, for example. In an embodiment according to the present invention, the external sealing gasket 290B may be made of a compressible material. The external sealing gasket 290B may be formed to encompass a large elliptical area, for example, to ensure inclusion of any off-center receiver acoustical openings and to accommodate different acoustical opening configurations associated with different cellphone models.

Acoustic sealing of the adaptor 210B to the surface of the cellphone 130 is desirable to minimize external sound pickup, but complete sealing is not essential. Modern cellphones employ a “leak-tolerant” design that minimizes response and level differences with variation in acoustic seals.

In an embodiment according to the present invention, the external sealing gasket 290B may also serve to secure the adaptor 210B to the cellphone 130. In an embodiment according to the present invention, the high-friction properties of the external sealing gasket 290B, along with similar gripping properties from the attaching mechanism (not shown) ensure secure mounting of the adaptor 210B to the cellphone 130.

In an embodiment according to the present invention, a method employed to ensure a flat frequency response through a receiving telecoil may be comparable to that described in U.S. Non-Provisional Patent Application having Ser. No. 10/356,290, entitled “Multi-Coil Coupling System for Hearing Aid Applications”, and filed on Jan. 31, 2003. A difference may be that a net response may be limited to 300 Hz to 3 kHz, because that is the range of valid acoustic input from the receiver of a cellphone 130. Any sound pickup outside of the 300 Hz to 3 kHz frequency range may be attenuated.

FIG. 2C is a graph 200C illustrating exemplary relative inductor drive voltages and total coupling response in decibels (dB) 289C versus frequency (Hz) 299C for an exemplary magnetic coupling adaptor, such as adaptor 110 illustrated in FIG. 1, according to an embodiment of the present invention. FIG. 2C illustrates relative drive voltages and total coupling response across a plurality of different frequencies, (from 100 Hz to 10 kHz), for example, wherein it is desirable to examine the behavior of the magnetic coupling in a typical hearing aid telecoil. A typical hearing aid telecoil may be adapted to respond essentially to a rate of change of an applied magnetic field for frequencies below 1 kHz and to a magnitude of the magnetic field for frequencies above 1 kHz. The inductor (150 of FIG. 1, for example) in this example may have an L/R ratio of 280 μsec. Three different measurements are illustrated in FIG. 2C: the adaptor transmitter (TX) inductor drive voltage required to obtain a flat total response through the typical hearing aid telecoil 263C; the actual TX inductor drive voltage drive employed 267C; and the net actual complete coupling response resulting from drive voltage 267C, including a typical hearing aid telecoil response 269C.

Illustrated in FIG. 2C is the actual inductor drive voltage frequency response and the resultant flat, band-limited net frequency response through a telecoil 269C, relative to the adaptor input. The actual total response may depend upon the frequency response of the acoustic output of the cellphone, for example, cellphone 130 illustrated in FIG. 1. The cellphone manufacturer may provide the acoustic output frequency response of the cellphone within appropriate standards.

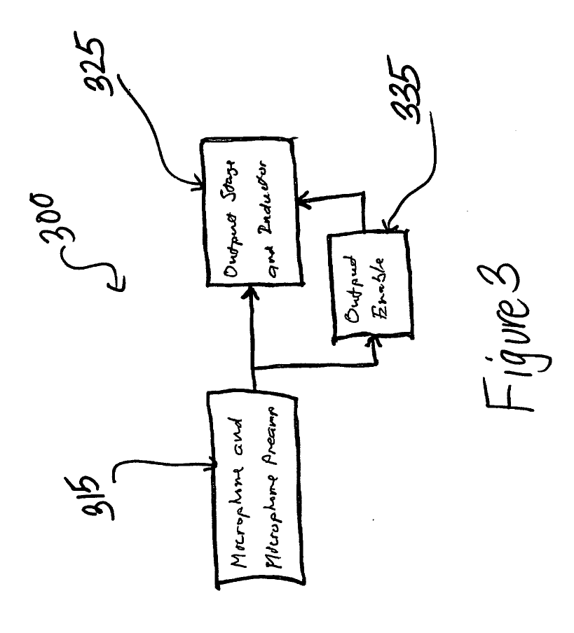

FIG. 3 is a block-diagram 300 illustrating functional components of an exemplary magnetic coupling adaptor, such as, for example, adaptor 110 illustrated in FIG. 1, according to an embodiment of the present invention. The adaptor 110, for example, may comprise a microphone and microphone preamplifier 315, an output stage and inductor 325, and output enable circuitry 335. The microphone preamplifier 315 may amplify the microphone signal and provide frequency response shaping. The output stage 325 may provide additional amplification to drive the inductor, such as inductor 250B illustrated in FIG. 2B, for example, and may also contribute to frequency response shaping. The output enable circuitry 336 may sense when significant acoustic input exists and power-up the output stage 325. The total battery current at idle may be approximately 6 μA. Powering-up the output stage 325 may add 100 μA, plus several hundred μA more, intermittently, depending upon a particular momentary speech signal level.

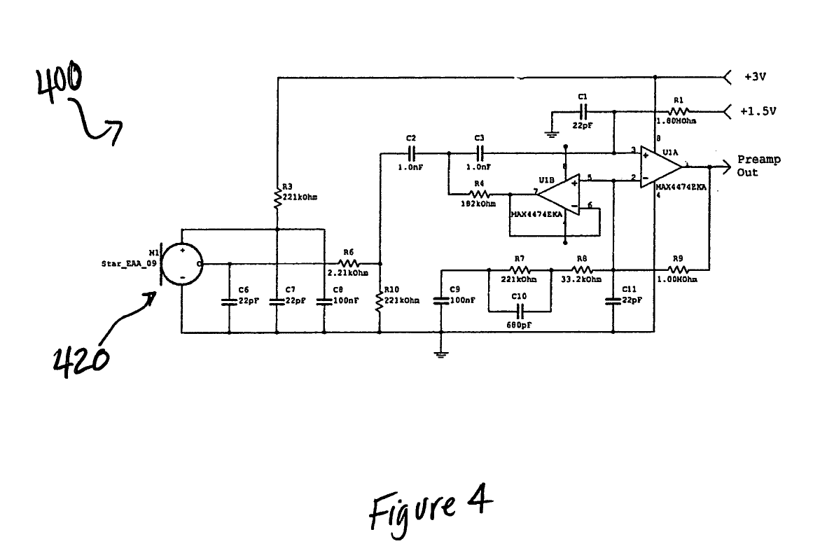

FIG. 4 is a circuit diagram illustrating a microphone and microphone preamplifier circuit 400 of an exemplary magnetic coupling adaptor, such as, for example, adaptor 110 illustrated in FIG. 1, according to an embodiment of the present invention. FIG. 4 illustrates the microphone and microphone preamplifier circuitry, as illustrated in FIG. 3, for example. Resistors R3 and R6, and capacitors C6, C7, and C8 may provide RF and power supply filtering to the microphone 420.

In an embodiment according to the present invention, the microphone 420 may comprise a Star Micronics EAA-09-AP electret condenser microphone, for example, containing an internal impedance conversion stage consisting primarily of a field effect transistor (FET) in a source-follower configuration, with the source connected to the “O” terminal. Unlike other similar microphones, there is no internal load resistor between the “O” terminal and the ground terminal (“-”) in microphone 420. The microphone, according to the present invention, allows for a very high value of external load resistance, which may minimize the supply current drawn by the FET.

In an embodiment according to the present invention, the value of resistor RIO may be 10 times higher than resistors typically used and may force a microphone idle current of approximately 3 μA. The very low idle current may raise the noise floor of the microphone 420, but this may not be important in relation to the 80 dB to 90 dB SPL levels that microphone 420 may encounter.

The microphone preamplifier circuitry 400 may employ a MAX 4474 EKA dual op-amp, which may have an idle current of approximately 0.7 μA per amplifier stage. The op-amp may provide a low gain-bandwidth, a low output drive capability, and a high input noise voltage, relative to most op amps. Resistors R1 and R4, and capacitors C2 and C3, in conjunction with op-amp U1A may form an under-damped 280 Hz high-pass filter that may cut off the out-of-band lower frequencies while giving a modest boost to the frequencies at the lower end of the passband. Op-amp U1B may prevent the high-pass filter components from loading the high impedance main op-amp feedback network. The feedback network may be made up of resistors R7, R8, and R9, and capacitors C9 and C10, and may be maintained at a high impedance level to avoid straining the output capabilities of op-amp U1A. The feedback network may provide the high frequency boost portion of the equalization. The low gain-bandwidth of op-amp U1A may limit the response above 3 kHz. Capacitors C1 and C11 may provide RF filtering.

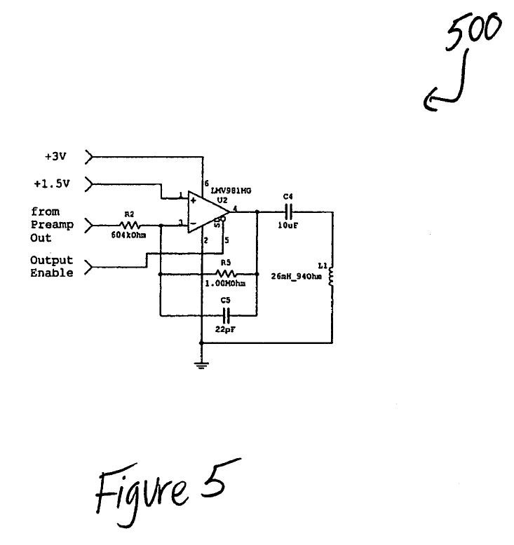

FIG. 5 is a circuit diagram illustrating output circuitry 500 of an exemplary magnetic coupling adaptor, such as adaptor 110 illustrated in FIG. 1, according to an embodiment of the present invention. FIG. 5 illustrates the output stage, consisting of op-amp U2, associated components, and inductor L1. Inductor L1 may preferably be a rod inductor, such as, for example, inductor 250B illustrated in FIG. 2B, wound for an inductance of 26 mH and a resistance of 94 Ohms, for example. The inductor L1 may accept, with a few dB to spare, the full voltage output of op-amp U2 without saturation. Capacitor C4, in conjunction with inductor L1, may form an additional high-pass filter at approximately 310 Hz, to complete the low frequency equalization. Resistors R2 and R5, and capacitor C5 may determine the stage gain and roll off the response further above the passband, completing the high frequency equalization.

Op-amp U2 may be an LMV 981 manufactured by National Semiconductor, for example, and may be capable of driving the moderately low load impedance presented by inductor L1. But if left on, an idle current of 100 μA would limit battery life to approximately 1,100 hours, or 47 days. Employing an on/off switch to engage the adaptor, such as, for example, adaptor 110 illustrated in FIG. 1, may increase the battery life. If op-amp U2 is shut down when the adaptor is not in use, however, the battery life may be extended to essentially the battery's shelf life of several years. When pin 5 of op-amp U2 is held low, the current drain may be less than 1 μA.

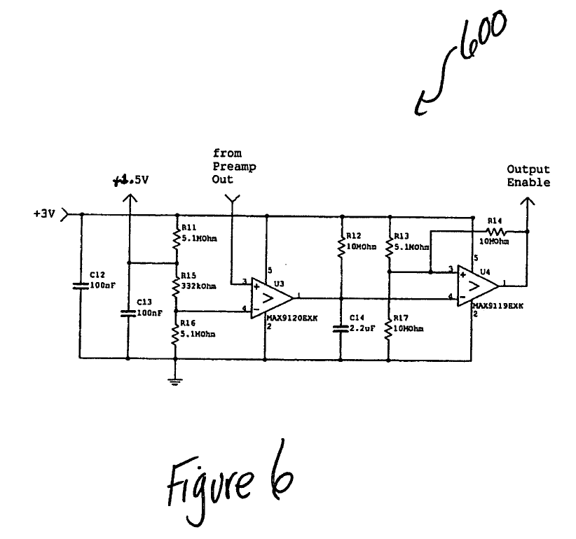

FIG. 6 is a circuit diagram illustrating output enable and supply bypassing circuitry 600 of an exemplary magnetic coupling adaptor, such as, for example, adaptor 110 illustrated in FIG. 1, according to an embodiment of the present invention. Capacitors C12 and C13 may provide supply filtering and bypassing. Resistors R11, R15, and R16 may provide a 1.5 V bias voltage for the preamp and output stages illustrated in FIGS. 4 and 5, and a voltage of 95 mV for a reference voltage to comparator U3, which may be a MAX 9120 manufactured by Dallas Semiconductor, for example. The comparator U3 may use 0.7 HA of supply current and have an open drain output. At rest, the comparator U3 output at pin 1 may be pulled high by resistor R12. This holds the output of comparator U4 low, keeping the output stage of FIG. 5 in a disabled state. Comparator U4 may be a MAX 9119 manufactured by Dallas Semiconductor, for example, which may also use 0.7 μA of supply current, but may have a push-pull output able to drive the output stage enable pin without additional idle current drain from a pull-up resistor. When the preamp output voltage level appearing at comparator U3 pin 3 momentarily goes more than 94 mV below the 1.5 V bias reference voltage due to a speech peak at the microphone of greater than about 90 dB SPL, the output of comparator U3 may be driven low, discharging capacitor C14. The output of comparator U4 may go high, enabling the output stage. Capacitor C14, in conjunction with resistors R12, R13, R14, and R17, may maintain the enabled state for about 30 seconds, for example, past the last acoustic input trigger.

The total current drain for the output enable and supply-bypassing circuitry at idle may be about 6 μA. With the output stage of the output enable and supply bypassing circuitry enabled, the current drain may be about 100 μA, with several hundred μA intermittently added when speech is present. Allowing for typical use patterns, well over a year of use may be obtained on a single 225 mA/hr rated CR-2032 battery. With the above-disclosed circuitry, the inclusion of an on/off switch to extend battery life may be obviated. In practice, the battery life may be lengthened in comparison to an embodiment having inclusion of an on/off switch that may be unintentionally left on. A difficulty that an end-user may experience when forgetting to turn on a power switch is also avoided.

In an embodiment according to the present invention, an on/off switch may be incorporated into the attachment mechanism. The automatic start-up circuit described may be effective for achieving convenient and reliable operation for the end-user.

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and the appended diagrams. It is intended that the scope of the invention be limited not with this detailed description, but rather by the claims appended hereto.

What is claimed is:

1. An adaptor attachable to an electronic device, the adaptor being arranged to interface between the electronic device and a hearing aid, the adaptor comprising:
a housing;
a power supply;
a signal-receiving device; and
a magnetic field-generating device, wherein the adaptor is arranged to receive a signal from the electronic device and employ the received signal to drive the magnetic field-generating device to magnetically couple with the hearing aid permitting a user of the hearing aid to receive the signal from the electronic device.

2. The adaptor according to claim 1, wherein the signal-receiving device is one of a microphone and an earphone jack.

3. The adaptor according to claim 1, wherein the adaptor is arranged to generate a magnetic field and position the magnetic field in a region comprising a weak magnetic noise field.

4. The adaptor according to claim 1, wherein the adaptor is arranged to generate a magnetic field and position the magnetic field in a region of reduced radio frequency energy.

5. The adaptor according to claim 1, wherein the adaptor is arranged to be attached to the electronic device and generate and position a magnetic field in a region at least a distance away from the electronic device.

6. The adaptor according to claim 1, wherein the adaptor is arranged to generate a magnetic field comprising strong components in directions adapted for coupling with at least one telecoil in a hearing aid.

7. The adaptor according to claim 1, wherein the adaptor is arranged to generate a magnetic field comprising strong components along directions that in use are vertical and outwardly direct horizontal with respect to a head of a hearing aid user.

8. The adaptor according to claim 1, wherein the magnetic field-generating device comprises an inductor, the inductor comprising a shape adapted to overcome magnetic noise field characteristics of an associated electronic device.

9. The adaptor according to claim 8, wherein the inductor comprises a rod inductor.

10. The adaptor according to claim 9, wherein the rod inductor comprises an iron core and a winding about at least a central portion of the iron core.

11. The adaptor according to claim 10, wherein the iron core has a length of approximately 20 mm and a diameter of approximately 0.6 mm, and the winding has a diameter of approximately 1 mm and a length along the iron core of approximately 12 mm.

12. The adaptor according to claim 8, wherein the inductor produces strong magnetic field components along directions that in use are vertical and outwardly directed horizontal with respect to a head of a hearing aid user.

13. The adaptor according to claim 1, wherein the adaptor is arranged to operate with a low operating power until encountering an input having a sufficient strength to cause the adaptor to enter an active mode.

14. The adaptor according to claim 1, further comprising a low idle power and a power-up circuit activated upon sensing a signal.

15. The adaptor according to claim 1, further comprising frequency shaping capabilities, wherein the adaptor is arranged to produce a flat, band-limited response from a telecoil circuit in the hearing aid over a particular frequency range.

16. The adaptor according to claim 15, wherein the particular frequency range comprises approximately a frequency range of cellular telephone communication.

17. The adaptor according to claim 15, wherein the particular frequency range comprises from approximately 300 Hz to approximately 3 kHz.

18. A method of interfacing between an electronic device and a hearing aid, the method comprising:
receiving a signal from the electronic device at an adaptor mountable to the electronic device, the adaptor having a housing;
driving a magnetic field-generating device in the adaptor with the received signal;
producing a magnetic field having a particular shape and direction by the adaptor;
coupling the hearing aid magnetically to the magnetic field produced by the adaptor; and
receiving the signal from the electronic device as an audible signal by a user of the hearing aid.

19. The method according to claim 18, wherein receiving a signal from the electronic device at the adaptor is accomplished via a signal-receiving device comprising one of a microphone and an earphone jack.

20. The method according to claim 18, wherein producing the magnetic field having the particular shape and direction by the adaptor comprises generating and positioning the magnetic field in a region comprising a weak magnetic noise field.

21. The method according to claim 18, wherein producing the magnetic field having the particular shape and direction by the adaptor comprises generating and positioning the magnetic field in a region of reduced radio frequency energy.

22. The method according to claim 18, wherein producing the magnetic field having the particular shape and direction by the adaptor comprises generating and positioning the magnetic field in a region at least a distance away from the electronic device.

23. The method according to claim 18, wherein producing the magnetic field having the particular shape and direction by the adaptor comprises generating the magnetic field comprising strong components in directions adapted for coupling with at least one telecoil in a hearing aid.

24. The method according to claim 18, wherein producing the magnetic field having the particular shape and direction by the adaptor comprises generating the magnetic field comprising strong components along directions that in use are vertical and outwardly directed horizontal with respect to a head of a hearing aid user.

25. The method according to claim 18, wherein producing the magnetic field having the particular shape and direction by the adaptor is accomplished by employing a magnetic field-generating device comprising an inductor, the inductor comprising a shape adapted to overcome magnetic noise field characteristics of an associated electronic device.

26. The method according to claim 25, wherein the inductor comprises a rod inductor.

27. The method according to claim 26, wherein the rod inductor comprises an iron core and a winding about a central portion of the iron core.

28. The method according to claim 27, wherein the iron core has a length of approximately 20 mm and a diameter of approximately 0.6 mm, and the winding has a diameter of approximately 1 mm and a length along the iron core of approximately 12 mm.

29. The method according to claim 25, wherein the inductor produces strong magnetic field components along directions that in use are vertical and outwardly directed horizontal with respect to a head of a hearing aid user.

30. The method according to claim 18, further comprising operating the adaptor with a low operating power until encountering an input having a sufficient strength to cause the adaptor to enter an active mode.

31. The method according to claim 18, further comprising operating the adaptor with a low idle power until powering-up based upon sensing a signal.

32. The method according to claim 18, further comprising shaping frequency characteristics to produce a flat, band-limited response over a particular frequency range.

33. The method according to claim 32, wherein the particular frequency range comprises approximately a frequency range of cellular telephone communication.

34. The method according to claim 32, wherein the particular frequency range comprises from approximately 300 Hz to approximately 3 kHz.
